(19) United States
(12) Patent Application Publication
(10) Pub. No.: US 2022/0176804 A1
(43) Pub. Date: Jun. 9, 2022

(54) INTEGRATED UPRIGHT AND DRIVE ELEMENTS

(71) Applicant: Divergent Technologies, Inc., Los Angeles, CA (US)

(72) Inventors: John Russell BUCKNELL, El Segundo, CA (US); Kevin Robert CZINGER, Santa Monica, CA (US); William David KREIG, Huntington Beach, CA (US); Jon Paul GUNNER, Palos Verdes, CA (US)

(21) Appl. No.: 17/543,681

(22) Filed: Dec. 6, 2021

Related U.S. Application Data
(60) Provisional application No. 63/122,345, filed on Dec. 7, 2020.

(51) Int. Cl. B60K 7/00; B60G 7/00; H02K 5/24; H02K 7/116; B60K 17/04

(52) U.S. Cl. CPC B60K 7/0007; B60G 7/008; B60G 2204/148; H02K 7/116; B60K 17/043; H02K 5/24

(57) ABSTRACT

Integration of drive elements with an unsprung structure is disclosed. In one aspect of the disclosure, a motor includes a stator configured to mount to an unsprung structure of a wheeled vehicle through at least a damper or a spring. The motor further includes a rotor configured to drive a wheel of the vehicle.

### CROSS REFERENCE TO RELATED APPLICATION(S)

This application claims the benefit of U.S. Provisional Application Ser. No. 63/122,345, entitled “INTEGRATED UPRIGHT AND DRIVE ELEMENTS” and filed on Dec. 7, 2020, the disclosure of which is expressly incorporated by reference herein in its entirety.

### BACKGROUND

### Field

The present disclosure relates generally to vehicles and other transport structures, and more particularly, to upright and wheel motors.

### Background

Electric vehicles allow for using additional motors or drive systems that were not feasible with traditional vehicles utilizing internal combustion engines. One such motor or drive system is a wheel motor or an in-wheel motor. Wheel motors may generally be located closer to wheels of a vehicle. The proximity to the wheels may allow for power to be transmitted faster or with less lag than a single motor coupled to multiple wheels of the vehicle via a long drive shaft.

However, the proximity of the wheel motors to the wheels result in the wheel motors being subjected to high vibrations from wheel accelerations. Generally, the wheel motors may be subjected to high vibrations throughout the entire travel time of the vehicle. The high vibrations may cause detrimental results in various components (e.g., precision components) of the wheel motors, e.g., frequent breakdowns, sub-optimal performance, etc.

To offset the impact of such high vibrations, conventional designs of the wheel motors have attempted to increase the structural rigidity of various components of the wheel motor. However, increasing the structural rigidity has also caused the weight of the wheel motor to increase. The increased weight of the wheel motor, however, negatively impacts ride and handling aspects of the vehicle. Thus, the various disadvantages of the conventional designs of the wheel motors pose challenges to the widespread adoption of wheel motors.

### SUMMARY

The following presents a simplified summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In various aspects, a motor is disclosed. The motor may be a wheel motor. The motor may include a stator. The stator may be configured to mount to an unsprung structure of a wheeled vehicle through at least a damper or a spring. The motor may further include a rotor. The rotor may be configured to drive a wheel of the vehicle.

In various aspects, a system is disclosed. The system may include a motor, an unsprung structure of a vehicle, a wheel of the vehicle, and a damper or a spring. The motor may include a stator and a rotor. The stator being configured to mount to the unsprung structure of the vehicle through at least one of the damper or the spring, and the rotor being configured to drive the wheel of the vehicle.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1 illustrates a cutaway view of a motor coupled to an unsprung structure, in accordance with various aspects of the present disclosure.

FIG. 2 illustrates a cutaway view of a motor coupled to an unsprung structure, in accordance with various aspects of the present disclosure.

FIG. 3 illustrates a cutaway view of a motor coupled to an unsprung structure, in accordance with various aspects of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

As described above, proximity of wheel motors to the wheels results in the wheel motors being subjected to high vibrations (e.g., 20 g) from wheel accelerations, which result in the components (e.g., electrical connections, inverters, batteries, circuit boards, and the like) of the wheel motors breaking down more frequently than desired or acceptable. Conventional techniques used to address the durability issues of such motors have caused the mass of these motors to increase, which negatively affects the ride and handling of the vehicle. This increased mass of the motors, when not properly accounted for in designs of other components of the vehicle, can cause such components to breakdown more frequently leading to higher maintenance costs and/or requiring redesigning or custom designing such components. For example, the increased mass of the motors may cause wheel bearings of the vehicle to breakdown more frequently.

Furthermore, it is generally desired for wheels of a vehicle to not rotate faster than 3000 revolutions per minute (rpm), and more often than not, to rotate slower than 2500 rpm. However, generally motors that rotate close to such desired wheel rpms have large diameters and are also heavy, thereby negatively affecting the ride and handling of the vehicle. Furthermore, such motors may be too large to even be successfully integrated into an unsprung structure (e.g., upright) of the vehicle. Additionally, such motors are generally inefficient and have low performance than motors with smaller diameters. For example, a motor with a small diameter (e.g., 400 millimeter diameter) may have a higher maximum rpm (e.g., 30,000 rpms) for the same amount of power applied to motors with larger diameters without exceeding mechanical stress limits of the motor's components.

While motors with smaller diameters may be more efficient and have higher performance than motors with larger diameters, greater speed reduction may be needed to drive the wheels of the vehicles at the desired rpms. However, speed reducers are generally heavy and, when located in-line along the axis of rotation of the motor, do not share walls with any other structure of the vehicle, which may result in a structurally inefficient design of the vehicle and may cause the mass of the vehicle to increase. Additionally, speed reducers that are located in-line along with axis of rotation of the motor may be limited to handle speed reductions of around 3:1. Therefore, the options for the motors that can be utilized will be limited to the slower, larger, inefficient and heavier motors, which as discussed above can cause various ride and handling issues for the vehicle.

Accordingly, the present disclosure is generally directed to techniques for integrating a lightweight motor into and/or with an unsprung structure of a vehicle and for isolating of the motor to reduce the impacts from high vibrations from the wheel of the vehicle. As described herein, an unsprung structure is a structure whose weight is not borne by a suspension system of a vehicle. Examples of an unsprung structure include, but are not limited to, an upright, a hub, a brake caliper, a wheel, and the like of the vehicle. As described herein, a sprung structure may be a structure of the vehicle whose weight is borne by the springs of the vehicle's suspension systems. A sprung structure may be on the vehicle side of suspension springs. Examples of the sprung structure may include, but are not limited to, chassis, engine, passenger compartment, and other similar structures of the vehicle. Generally, most structures of the vehicle may be sprung structures.

In one aspect of the disclosure, a lightweight motor may be mounted to an unsprung structure of the vehicle. A speed reducer may be located off the axis of rotation of the motor. A portion of the speed reducer may be coupled to the axle and/or hub of the vehicle via a flexible linkage, and another portion of the speed reducer may be coupled to the motor. In some implementations, the speed reducer may include multiple gear reducers or one or more gear sets. For example, the speed reducer may include a first gear reducer and a second gear reducer different from the first gear reducer. The first gear reducer may be coupled to the motor and a second gear reducer may be coupled to the axle and/or hub of the vehicle.

The lightweight motor may be coupled to a set of swing arms at a first set of connection points and the set of swing arms may be coupled to the unsprung structure at a second set of connection points on the unsprung structure. The lightweight motor being coupled to the set of swing arms allows for the motor to be suspended, which allows for the motor to be isolated from the vibrations from vehicle's wheel accelerations. The isolation from the accelerations improves the durability of the various components of the motor.

Vibrations from the wheel and/or other structures of the vehicle may cause the swing arm to swing. The swing arm may swing in an arc and may cause the motor to swing in the arc of the swing arm. The motor may be meshed with a portion of the speed reducer and remain meshed with that portion speed reducer while the motor swings in the arc of the swing arm.

The motor may be mounted to the unsprung structure via a spring and/or a damper. In some implementations, the motor may be mounted to an outside of the unsprung structure. In some implementations, the spring and/or the damper may connect to motor at one set of connection of points and they may be connected to a sprung structure (e.g., chassis of the vehicle) at another set of connection points. In some implementations, the motor may be located within a hollow portion of the unsprung structure, and the spring and/or damper may be connected to the unsprung structure at another set of connection points. In some implementations, the motor may be mounted to an outside of the unsprung structure and the spring and/or damper may be connected at a first set of connection points to the motor, and, at a second set of connection points, the spring and/or damper may be connected to the unsprung structure.

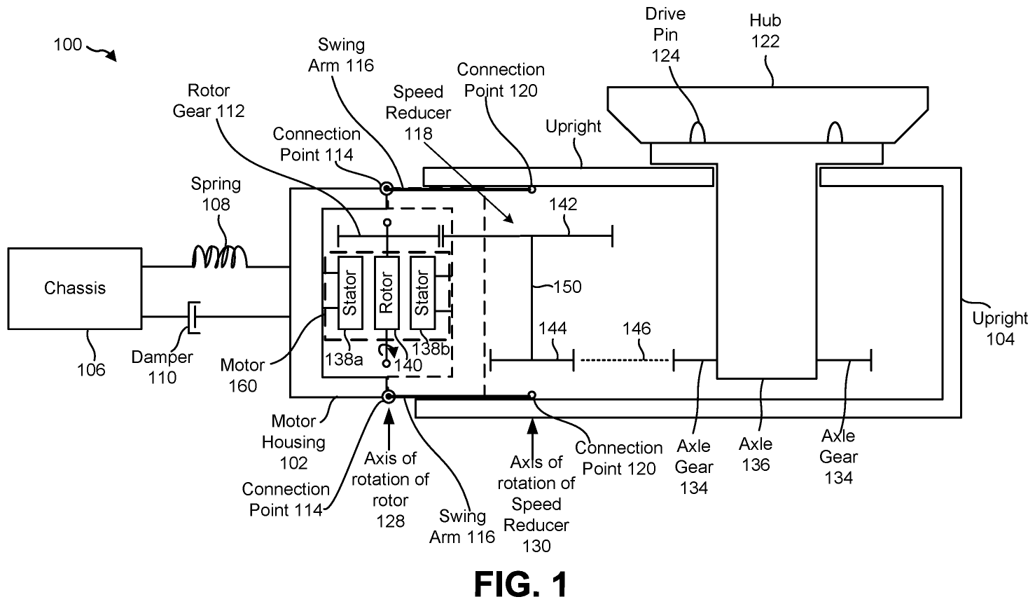

Additional details of the integration of the motor with and/or into an unsprung structure are describe herein with respect to FIGS. 1-3.

Turning now to FIG. 1, there is shown a cutaway view of an integration 100 of the motor with an unsprung structure. In FIG. 1, a motor 160 may include a motor housing 102. The motor 160 may include a stator, shown in two portions stator 138a and 138b, and a rotor 140. The rotor 140 of the motor 160 may rotate along an axis of rotation 128, as shown in FIG. 1, when power is delivered to the motor 160. The motor 160 may be a lightweight, high performance, efficient motor. For example, the motor 160 may be configured to spin up to a maximum of 30,000 rpms without exceeding mechanical stress limits of the various components of the motor 160. In some implementations, the motor 160 may be a small motor. In some implementations, the diameter of the motor 160 may be less than 500 millimeters (mm). For example, the diameter of the motor 160 may be 400 mm. The stators 138a, 138b may be connected to a portion motor housing 102. For example, as shown in FIG. 1, the stators 138a and/or 138b may be connected at a first set of connection points on the motor housing 102.

As described above, in some implementations, a motor may be mounted to an outside of the unsprung structure. An example of such an implementation is shown in FIG. 1. In FIG. 1, the motor 160 through the motor housing 102 is mounted to an outside of the unsprung structure 104. For the purpose of illustrating a clear example, the unsprung structure 104 is depicted as an upright in FIG. 1. However, as described above, examples of the unsprung structure may include, but are not limited to, an upright, a hub, a brake caliper, and the like of the vehicle. Accordingly, persons skilled in the art should appreciate that in some implementations, unsprung structures other than an upright may also be utilized.

The motor housing 102 may be mounted to the unsprung structure 104 via a structure that allows independent movement of the motor and the unsprung structure, such as through a set of swing arms 116 at connection points 114 as shown in FIG. 1. In some implementations, as shown in FIG. 1, the connection points 114 may be along the axis of rotation of the rotor 140. Another portion of the set of swing arms 116 may be connected to the unsprung structure 104, for example at connection points 120, as shown in FIG. 1. Connection points 120 may be along the axis of rotation 130 of a gear of a speed reducer 118, described in more detail below. In some implementations, having the swing arms connected at the axis of rotations 128 and 130 of the rotor 140 and the gear of the speed reducer 118, respectively, allows for the swing arms 116 to efficiently move and/or swing motor 160. In response to any vibrations from the wheel of the vehicle, the swing arms 116 may move or swing, for example, in an arc pattern, which causes the motor 160 through motor housing 102 to move or swing in the pattern.

The motor 160 remains engaged with the speed reducer 118 even while the motor 160 is moving or swinging in the pattern of the swing arms' motion and/or pattern (e.g., an arc pattern. In some implementations, the length of the swing arms 116 may be based on the sizes of one or more gears coupled to the motor 160. For example, the length of the swing arms 116 may be approximately equal to the sum of the radius of the rotor gear 112 and the radius of the gear 142 of the speed reducer 118.

Accordingly, the connection of the motor 160 via the swing arms 116, as shown in FIG. 1 and described above, can allow the motor to move independently of the upright and can help reduce the impact from any vibrations from the wheel of the vehicle on any components of the motor 160, which also improves the durability of the motor and/or its various components. For example, the connection of the motor 160 as shown in FIG. 1 and described herein with respect to FIG. 1 may reduce the force of vibrations experience by the motor 160 from 20 g to less than 6 g.

In some implementations, as shown in FIG. 1, the motor 160 may be coupled to and drive the wheel (not shown) of the vehicle via rotor gear 112, speed reducer 118, an axle 136, and/or a hub 122. The rotor 140 of the motor 106 may be connected to the rotor gear 112 via a linkage. Examples of linkage may include a shaft, a drive shaft, and the like. In some implementations, linkage may be a flexible linkage, such as a chain, belt, and the like. The rotor gear 112 may be engaged with the speed reducer 118. The motor 160 may be coupled to the speed reducer 118 via the rotor gear 112.

The speed reducer 118 may be configured to reduce the speed applied at the wheel by the motor from the rate at which the motor is revolving to a desired rpm of the wheel of the vehicle. The speed reducer 118 may include one or more sets of the gears, such as the gears 142 and 144, as shown in FIG. 1. Gears 142 and 144 may be connected via linkage 150. Examples of linkage 150 may include a shaft, a drive shaft, and the like. In some implementations, linkage 150 may be a flexible linkage, such as a chain, belt, and the like.

As shown in FIG. 1, the speed reducer 118 may be located off the axis of rotation 128 of the motor 160. Accordingly, the speed reducer 118 is not limited to the constraints of an on-axis speed reducer. For example, speed reducer 118 is not limited to be a planetary speed reducer. The speed reducer 118 may engaged with the motor 160 via the rotor gear 112. The speed reducer 118 may be engaged with the rotor gear 112 via gear 142. The gear 142 and the rotor gear 112 may be engaged with each other. For example, the teeth of the gear 142 and the teeth of the rotor gear 112 may engaged such that the rotor gear 112 successfully and efficiently drives the gear 142. Accordingly, the speed at which the motor 160 is revolving may be reduced by the gear ratio of the gear 142. The (larger) gear 142 drives the (smaller) gear 144 via the linkage 150. Thus, the speed transferred to the wheel may be further reduced by the gear ratio of the gears 144 and 142.

In some implementations, one or more of the gears 142, 144 may have a single gear ratio of 7.5:1. In some implementations, the speed reducer 118, via the gears 142 and 144, may have a two stage gear ratio of 25:1. Accordingly, via the gears 142 and 144, the speed reducer 118 may significantly reduce the high speeds at which the motor 160 may be revolving and help drive the wheel of the vehicle at a desired rpm for the wheel.

The speed reducer 118 may be coupled with axle 136 via an axle gear 134. As shown in FIG. 1, the axle gear 134 may be engaged with the gear 144 of the speed reducer 118 via a linkage 146. In some implementations, the linkage 146 may be a flexible linkage, such as a chain, an involute chain, and the like. In some implementations, the linkage 146 may be a shaft, a drive shaft, and the like. The axle 136 may be coupled to the wheel of the vehicle via the drive pin 124 and the hub 122. The axle 136 may be connected to the drive pin 124, as shown in FIG. 1. In some implementations, the drive pin 124 may protrude from the axle 136 and integrated with the axle 136. The drive pin 124 may be connected to the hub 122 as shown in FIG. 1, and the hub 122 may be connected to a wheel (not shown) of the vehicle. The gear 144 of the speed reducer 118 may drive the axle gear 134 and cause the wheel of the vehicle to revolve around an axis of rotation (e.g., axis of the rotation of the axle) at a desired rpm (e.g. between 1000 and 2500 rpms).

The motor housing 102 may be connected to at least a spring 108 and/or damper 110. The spring 108 and/or the damper 110 may be connected to the motor at a first set of connection points and at a second set of connection points, the spring 108 and/or the damper 110 may be connected to a sprung structure of the vehicle. For example, as shown in FIG. 1, the motor housing 102 is connected to the sprung structure 106 (e.g., chassis) through the spring 108 and/or the damper 110. Again, for the purpose of illustrating a clear example, the sprung structure 106 is depicted as a chassis of the vehicle in FIG. 1. However, as described above, a sprung structure may be any structure of the vehicle whose weight is borne by the springs of the vehicle's suspension systems, and examples of a sprung structure include, but are not limited to, chassis, engine, passenger compartment, and other similar structures of the vehicle. Accordingly, persons skilled in the art should appreciate that in some implementations, sprung structures other than the chassis may also be utilized.

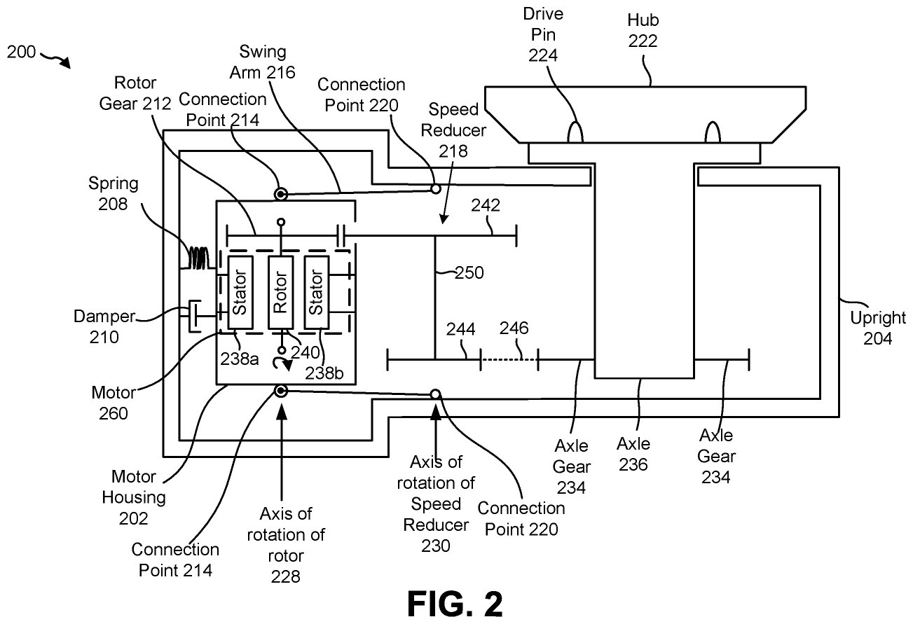

Turning now to FIG. 2, there is shown a cutaway view of an integration 200 of the motor 260 with an unsprung structure 204, e.g., an upright. Motor 260 may be similarly configured as motor 160 in FIG. 1. As described above, in some implementations, a motor may be located within a hollow portion of the unsprung structure 204. The motor 260 may be mounted to the inside of the unsprung structure 204. An example of such an implementation is shown in FIG. 2. In this way, for example, motor 260 may be better protected from environmental elements. In FIG. 2, the motor 260 through the motor housing 202 is mounted to an inside of the unsprung structure 204. Similar to FIG. 1, for the purpose of illustrating a clear example, the unsprung structure 204 is depicted as an upright in FIG. 2. However, persons skilled in the art would appreciate that in some implementations, unsprung structures other than an upright may also be utilized.

The motor housing 202 may be mounted to the unsprung structure 204 through at least a spring 208 and/or a damper 210. The spring 208 and/or the damper 210 may be connected to the motor 260 at a first set of connection points, and at a second set of connection points the spring 208 and/or the damper 210 may be connected to the unsprung structure 204 of the vehicle. For example, as shown in FIG. 2, the motor housing 202 is connected to the spring 208 and/or the damper 210 at one end of the spring 208 and/or the damper 210, and another end of the spring 208 and/or the damper 210 is connected to the unsprung structure 204.

The motor 260 may include a stator, shown as stator 238a, 238b, and a rotor 240. The rotor 240 of the motor 260 may rotate along an axis of rotation 228, as shown in FIG. 2. The motor 260 may be a lightweight, high performance, efficient motor. The diameter of the motor 260 may be less than 500 millimeters (mm). For example, the diameter of the motor 260 may be 400 mm. The stators 238a, 238b may be connected to a portion motor housing 202 as shown in FIG. 2 and similarly as stators 238a, 238b.

The motor 260 may be coupled to and drive the wheel (not shown) of the vehicle via a rotor gear 212, a speed reducer 218, an axle 236, and/or a hub 222. The rotor 240 of the motor 260 may be connected to the rotor gear 212 via a linkage. Examples of linkage may include a shaft, a drive shaft, and the like. In some implementations, linkage may be a flexible linkage, such as a chain, belt, and the like. The rotor gear 212 may be engaged with the speed reducer 218. The motor 260 may be coupled to the speed reducer 218 via the rotor gear 212.

The speed reducer 218 may be similarly configured as speed reducer 118. Accordingly, speed reducer 218 may reduce the speed applied at the wheel by the motor from the rate at which the motor is revolving to a desired rpm of the wheel of the vehicle. The speed reducer 218 may include one or more sets of the gears, such as the gears 242 and 244. Gears 242 and 244 may be connected via linkage 250. Examples of linkage 250 may include a shaft, a drive shaft, and the like. In some implementations, linkage 250 may be a flexible linkage, such as a chain, belt, and the like.

As shown in FIG. 2, the speed reducer 218, similar to speed reducer 118, may be located off the axis of rotation 228 of the motor 260. Accordingly, the speed reducer 218 is not limited to the constraints of an on-axis speed reducer. The speed reducer 218 may engaged with the motor 260 via the rotor gear 212. The speed reducer 218 may be engaged with the rotor gear 212 via gear 242. The gear 242 and the rotor gear 212 may be configured to be engaged with each other such that the rotor gear 212 successfully and efficiently drives the gear 242. The gear 242 drives the gear 244 via the linkage 250. Thus, the speed transferred to the wheel may be further reduced by the gear ratio of the gear 244 and 242. Gears 242 and 244 may be similarly configured as gears 142 and 144.

The speed reducer 218 may be coupled with axle 236 via the axle gear 234. As shown in FIG. 2, the axle gear 234 may be engaged with the gear 244 of the speed reducer 118 via the linkage 246. In some implementations, the linkage 246 may be a flexible linkage, such as a chain, an involute chain, and the like. In some implementations, the linkage 246 may be a shaft, a drive shaft, and the like. The axle 236 may be coupled to the wheel of the vehicle via the drive pin 224 and the hub 222. Therefore, the gear 244 of the speed reducer 218 may drive the axle gear 234 and cause the wheel of the vehicle to revolve around an axis of rotation (e.g., axis of the rotation of the axle) at a desired rpm (e.g. between 1000 and 2500 rpms).

Similar to motor 160 in FIG. 1, in the integration depicted in FIG. 2, the motor 260 remains engaged with the speed reducer 218 even while the motor 260 is moving or swinging in the pattern of the swing arms' 216 motion and/or pattern (e.g., an arc pattern). In some implementations, similar to the length of the swing arms 116, the length of the swing arms 216 may be based on the sizes of one or more gears coupled to the motor 260, such as the rotor gear 212 and the gear 242. For example, the length of the swing arms 216 may be approximately equal to the sum of the radius of the rotor gear 212 and the radius of the gear 242 of the speed reducer 218.

Accordingly, the benefits and/or advantages of suspending the motor 260 via the swing arms 216 are similar to the suspension of the motor 160 via the swing arms 116, as shown in FIG. 1 and described above. Motor 260, similar to motor 160, can be allowed to move independently of the upright, which can help reduce the impact from any vibrations from the wheel of the vehicle on any components of the motor 260, which also improves the durability of the motor 260 and/or its various components.

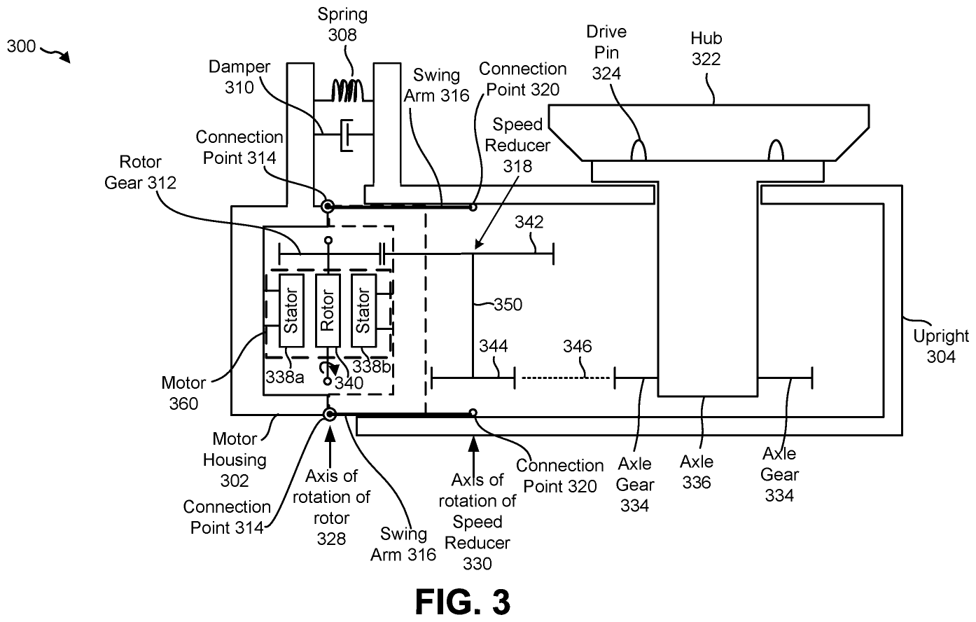

Turning now to FIG. 3, there is shown a cutaway view of an integration 300 of the motor 360 with an unsprung structure 304. Motor 360 is similarly configured as motors 160 and 260 as described in FIGS. 1 and 2. The integration 300 is similar to the integration 100 described in FIG. 2. However, in FIG. 3, the motor is mounted not completely inside of the unsprung structure. As illustrated in FIG. 3, a motor housing 302 can be located outside of an unsprung structure 304, e.g., an upright. In this way, for example, motor 360 may be more easily accessed, e.g., for repair or replacement. The remaining elements of FIG. 3 are similarly configured as the elements of FIG. 2, and have similar advantages as the integration depicted in FIG. 2. Similar to FIG. 2, for the purpose of illustrating a clear example, the unsprung structure 304 is depicted as an upright in FIG. 3. However, persons skilled in the art would appreciate that in some implementations, unsprung structures other than an upright may also be utilized.

The motor housing 302 may be mounted to the unsprung structure 304 through at least a spring 308 and/or a damper 310. The spring 308 and/or the damper 310 may be connected to the motor 360 at a first set of connection points, and at a second set of connection points the spring 308 and/or the damper 310 may be connected to the unsprung structure 304 of the vehicle. For example, as shown in FIG. 3, the motor housing 302 is connected to the spring 308 and/or the damper 310 at one end of the spring 308 and/or the damper 310, and another end of the spring 308 and/or the damper 310 is connected to the unsprung structure 304.

The motor 360 may include a stator, shown as stator 338a, 338b, and a rotor 340. The rotor 340 of the motor 360 may rotate along an axis of rotation 328, as shown in FIG. 3. The motor 360 may be a lightweight, high performance, efficient motor. The diameter of the motor 360 may be less than 500 millimeters (mm). For example, the diameter of the motor 360 may be 400 mm. The stators 338a, 338b may be connected to a portion motor housing 302 as shown in FIG. 3 and similarly as stators 338a, 338b.

The motor 360 may be coupled to and drive the wheel (not shown) of the vehicle via a rotor gear 312, a speed reducer 318, an axle 336, and/or a hub 322. The rotor 340 of the motor 360 may be connected to the rotor gear 312 via a linkage. Examples of linkage may include a shaft, a drive shaft, and the like. In some implementations, linkage may be a flexible linkage, such as a chain, belt, and the like. The rotor gear 312 may be engaged with the speed reducer 318. The motor 360 may be coupled to the speed reducer 318 via the rotor gear 312.

The speed reducer 318 may be similarly configured as speed reducer 118. Accordingly, speed reducer 318 may reduce the speed applied at the wheel by the motor from the rate at which the motor is revolving to a desired rpm of the wheel of the vehicle. The speed reducer 318 may include one or more sets of the gears, such as the gears 342 and 344. Gears 342 and 344 may be connected via linkage 350. Examples of linkage 350 may include a shaft, a drive shaft, and the like. In some implementations, linkage 350 may be a flexible linkage, such as a chain, belt, and the like.

As shown in FIG. 3, the speed reducer 318, similar to speed reducer 118, may be located off the axis of rotation 328 of the motor 360. Accordingly, the speed reducer 318 is not limited to the constraints of an on-axis speed reducer. The speed reducer 318 may engaged with the motor 360 via the rotor gear 312. The speed reducer 318 may be engaged with the rotor gear 312 via gear 342. The gear 342 and the rotor gear 312 may be configured to be engaged with each other such that the rotor gear 312 successfully and efficiently drives the gear 342. The gear 342 drives the gear 344 via the linkage 350. Thus, the speed transferred to the wheel may be further reduced by the gear ratio of the gear 344 and 342. Gears 342 and 344 may be similarly configured as gears 142 and 144.

The speed reducer 318 may be coupled with axle 336 via the axle gear 334. As shown in FIG. 3, the axle gear 334 may be engaged with the gear 344 of the speed reducer 118 via the linkage 346. In some implementations, the linkage 346 may be a flexible linkage, such as a chain, an involute chain, and the like. In some implementations, the linkage 346 may be a shaft, a drive shaft, and the like. The axle 336 may be coupled to the wheel of the vehicle via the drive pin 324 and the hub 322. Therefore, the gear 344 of the speed reducer 318 may drive the axle gear 334 and cause the wheel of the vehicle to revolve around an axis of rotation (e.g., axis of the rotation of the axle) at a desired rpm (e.g. between 1000 and 2500 rpms).

Similar to motor 160 in FIG. 1, in the integration depicted in FIG. 3, the motor 360 remains engaged with the speed reducer 318 even while the motor 360 is moving or swinging in the pattern of the swing arms' 316 motion and/or pattern (e.g., an arc pattern). In some implementations, similar to the length of the swing arms 116, the length of the swing arms 316 may be based on the sizes of one or more gears coupled to the motor 360, such as the rotor gear 312 and the gear 342. For example, the length of the swing arms 316 may be approximately equal to the sum of the radius of the rotor gear 312 and the radius of the gear 342 of the speed reducer 318.

Accordingly, the benefits and/or advantages of suspending the motor 360 via the swing arms 316 are similar to the suspension of the motor 160 via the swing arms 116, as shown in FIG. 1 and described above. Motor 360, similar to motor 160, can be allowed to move independently of the upright, which can help reduce the impact from any vibrations from the wheel of the vehicle on any components of the motor 360, which also improves the durability of the motor 360 and/or its various components.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A motor, comprising:
a stator configured to mount to an unsprung structure of a wheeled vehicle through at least a damper or a spring; and
a rotor configured to drive a wheel of the vehicle.

2. The motor of claim 1, wherein the stator is further configured to mount to the unsprung structure through a swing arm.

3. The motor of claim 2, further comprising a first gear coupled to the rotor, the first gear having a first radius, wherein a first gear is configured to mesh with a second gear, the second gear having a second radius, wherein a length of the swing arm is approximately equal to the sum of the first radius and the second radius, such that the first gear and the second gear remain meshed when the stator swings in an arc of the swing arm.

4. The motor of claim 1, wherein the rotor is further configured to couple to the wheel through a speed reducer.

5. The motor of claim 4, further comprising:
a first gear coupled to the rotor, wherein the first gear is configured to mesh with a second gear of the speed reducer.

6. The motor of claim 1, further comprising:
a housing, wherein the stator is configured to be mounted to the unsprung structure through the housing.

7. The motor of claim 1, wherein the unsprung structure includes an upright.

8. The motor of claim 1, wherein the unsprung structure includes a hollow portion, and the stator is configured to be mounted inside the hollow portion through at least the damper or the spring.

9. The motor of claim 1, wherein the stator is configured to be mounted to an outside of the unsprung structure.

10. A system for a vehicle comprising:
an unsprung structure configured to couple to a wheel of the vehicle;
at least a damper or a spring; and
a motor, wherein the motor comprises:
a stator configured to mount to the unsprung structure through at least the damper or the spring; and
a rotor configured to drive the wheel.

11. The system of claim 10, wherein the stator is further configured to mount to the unsprung structure through a swing arm.

12. The system of claim 11, further comprising:
a first gear and a second gear,
wherein the first gear is coupled to the rotor, the first gear having a first radius, and configured to mesh with the second gear,
the second gear having a second radius, and wherein a length of the swing arm is approximately equal to the sum of the first radius and the second radius, such that the first gear and the second gear remain meshed when the stator swings in an arc of the swing arm.

13. The system of claim 10, further comprising:
a speed reducer, wherein the rotor is further configured to couple to the wheel through the speed reducer.

14. The system of claim 13, further comprising:
a first gear coupled to the rotor, wherein the first gear is configured to mesh with a second gear.

15. The system of claim 10, further comprising:
a housing, wherein the stator is configured to be mounted to the unsprung structure through the housing.

16. The system of claim 10, wherein the unsprung structure includes an upright.

17. The system of claim 10, wherein the unsprung structure includes a hollow portion, and the stator is configured to be mounted inside the hollow portion through at least the damper or the spring.

18. The system of claim 10, wherein the stator is configured to be mounted to an outside of the unsprung structure.

19. The system of claim 10, further comprising:
a first gear coupled to the rotor; and
a speed reducer comprising one or more gears, wherein at least one gear of the one or more gears of the speed reducer is coupled to the first gear.

20. The system of claim 19, further comprising:
a second gear coupled to the wheel of the vehicle, wherein at least another gear of the one or more gears of the speed reducer is coupled to the second gear.

21. The system of claim 20, wherein the at least another gear of the one or more gears of the speed reducer is coupled to the second gear via a flexible linkage.

22. The system of claim 21, wherein the flexible linkage is an involute chain.

23. The system of claim 20, wherein a gear ratio of the at least one gear of the one or more gears of the speed reducer is different than the gear ratio of the at least another gear of the one or more gears of the speed reducer.

24. The system of claim 20, wherein the at least one gear of the one or more gears of the speed reducer has a same axis of rotation as the at least another gear of the one or more gears of the speed reducer, and wherein the at least one gear is connected to the at least another gear along the same axis of rotation.

25. The system of claim 10, wherein at least one of the damper or the spring is connected to a sprung structure of the vehicle.

26. The system of claim 25, wherein the sprung structure of the vehicle is at least one of a chassis of the vehicle, a passenger compartment of the vehicle, or an engine of the vehicle.

27. The system of claim 11, wherein a first portion of the swing arm connects to a housing comprising the motor at a first connection point on the housing and s second portion of the swing arm connects to the unsprung structure at a second connection point on the unsprung structure.

28. The system of claim 27, wherein the first connection point is along the axis of rotation of the rotor.

29. The system of claim 27, wherein the second connection point is along the axis of rotation of a gear of a speed reducer.

30. The system of claim 29, wherein the speed reducer is arranged within a hollow portion of the unsprung structure of the vehicle.
